(19) United States
(12) Patent Application Publication
(10) Pub. No.: US 2005/0251590 A1
(43) Pub. Date: Nov. 10, 2005

(54) Peripheral device that receives an icon from an information handling system

(75) Inventors: Christa Ann Ferguson, Round Rock, TX (US); Mohammed Reza Aidinejad, Austin, TX (US); Dustin Sorenson, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/842,156

(22) Filed: May 10, 2004

(51) Int. Cl. G06F 3/00; H04N 1/32; G06F 15/177

(52) U.S. Cl. 710/8; 358/442; 713/1; 710/10

(57) ABSTRACT

In a peripheral device including a display device, the peripheral device includes a storage device, coupled to the display device, which stores instructions that when executed, cause the peripheral device to output a request for an icon associated with a computer program, receive the icon, and display the icon on the display device.

### BACKGROUND

The description herein relates generally to information handling systems (“IHSs”) and more particularly to IHSs coupled to peripheral devices.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some peripheral devices (e.g., printers, scanners, cameras, and audio players) are capable of performing their various operations in association with a specific computer program (e.g., Microsoft Excel and Microsoft Word). For example, in the case of a user who wishes to scan a document for storage on an IHS, a scanner may display on its display panel, a menu including items selectable by the user to scan the document in a format supported by a particular computer program. Thus, the user is capable of specifying a computer program, in association with which the peripheral device performs its operation.

In one conventional technique, a peripheral device displays a menu of one or more computer programs associated with an operation. For each of the computer programs, the peripheral device displays a name or another textual representation. Unfortunately, users sometimes select an unintended computer program when confronted with a menu of computer programs' names or textual representations.

What is needed is a peripheral device and technique without the disadvantages described above.

### SUMMARY

Accordingly, a peripheral device including a display device is disclosed. The peripheral device includes a storage device, coupled to the display device, which stores instructions that when executed cause the peripheral device to output a request for an icon associated with a computer program, receive the icon, and display the icon on the display device.

### BRIEF DESCRIPTION OF THE DRAWINGS

FIG. 1 is a block diagram of an information handling system (“IHS”) according to an illustrative embodiment.

FIG. 2A is a block diagram of a peripheral device coupled to the IHS of FIG. 1, according to an illustrative embodiment.

FIG. 2B is an illustration of a visual image (e.g., “screen”) displayed by the display device of FIG. 2A.

FIG. 2C is a block diagram of devices that are representative of the peripheral device of FIG. 2A.

FIG. 3 is a flow chart illustrating operations performed by the peripheral device of FIG. 1.

### DETAILED DESCRIPTION

For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. Example of an IHS include, personal computer (“PC”), a network storage device, persona digital assistant, or any other suitable device with variations in size, shape, performance, functionality, and price. An IHS also includes other components such as, random access memory (“RAM”), one or more processing resources (e.g., central processing unit (“CPU”), hardware or software control logic, read only memory (“ROM”), other types of memory, one or more disk drives, one or more network interfaces, one or more input/output devices and/or one or more buses.

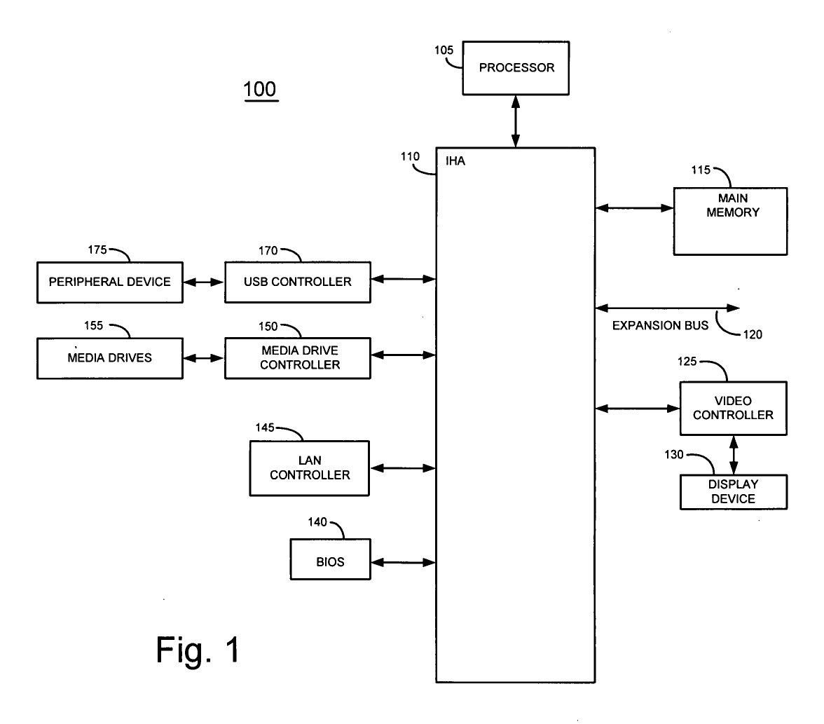

FIG. 1 is a block diagram of an IHS indicated generally at 100, according to the illustrative embodiment. The IHS 100 includes a processor 105 (e.g., an Intel Pentium series processor). An Intel Hub Architecture (IHA) chipset 110 provides the IHS 100 with graphics/memory controller hub functions and I/O functions. More specifically, the IHA chipset 110 acts as a host controller which communicates with a video controller 125 coupled thereto. A display device 130 is coupled to the video controller 125.

The chipset 110 further acts as a controller for main memory 115 which is coupled thereto. The chipset 110 also acts as an input/output (“I/O”) controller hub (ICH) which performs I/O functions. A USB controller 170 is coupled to chipset 110 so that devices such as a peripheral device 175 can be connected to the chipset 110 and the processor 105. Examples of the peripheral device 175 include printers, cameras, scanners, audio players, and other suitable devices. Although the peripheral device 175 communicates with the IHS 100 via a USB interface in the illustrative embodiment, in other embodiments, the peripheral device 175 communicates with the IHS 100 via another type of interface such as serial, parallel, FireWire, and/or any other suitable connection interface. A system basic input-output system (“BIOS”) 140 is coupled to chipset 110 as shown. The BIOS 140 is stored in CMOS or FLASH memory so that it is nonvolatile.

A local area network (LAN) controller 145, alternatively called a network interface controller (NIC), is coupled to the chipset 110 to facilitate connection of the IHS 100 to other IHSs. A media driver controller 150 is coupled to chipset 110 so that devices such as media drives 155 can be connected to the chipset 110 and the processor 105. Examples of the media devices 155 capable of being coupled to the media controller 150 include CD-ROM drives, DVD drives, hard disk drives and other fixed or removable media drives. An expansion bus 120, such as a PCI bus, PCI express bus, serial advanced technology attachment (SATA) bus or other bus is coupled to the chipset 110 as shown. The expansion bus 120 includes one or more expansion slots (not shown) for receiving expansion cards which provide the IHS 100 with additional functionality.

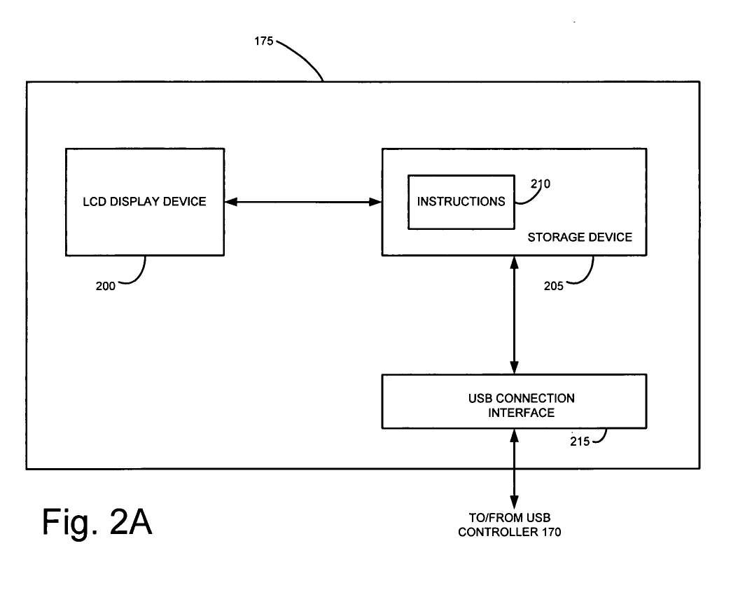

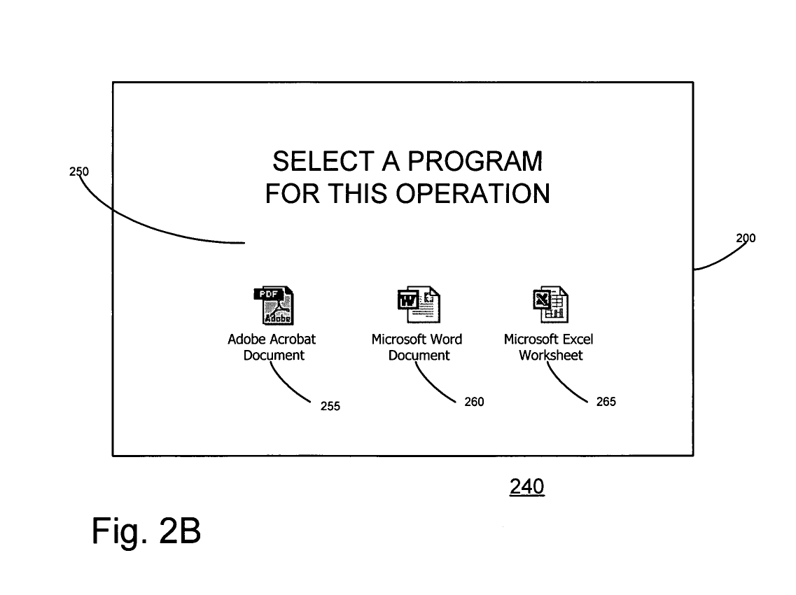

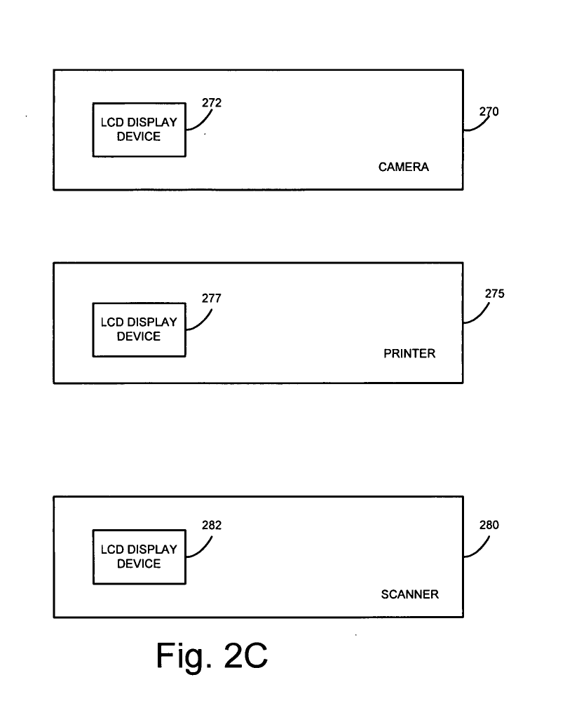

FIG. 2A is a more detailed block diagram of the peripheral device 175. The peripheral device 175 includes a display device 200 for displaying to a user, information (e.g., peripheral device 175's status or configuration information) associated with the peripheral device 175's operation. In the illustrative embodiment, the display device 200 is a liquid crystal display (“LCD”) panel. However, in other embodiments, the display device 200 is any other suitable type of display device.

The peripheral device 175 also includes a storage device 205, which is coupled to the display device 200. The storage device 205 is an erasable programmable read only memory (“EPROM”) or any other suitable storage device for storing various information associated with the peripheral device 175.

The storage device 205 stores information (e.g., instructions and/or data) about the peripheral device 175. For example, in the illustrative embodiment, the storage device 205 stores instructions 210. The instructions 210 are stored as firmware and include information associated with the peripheral device 175, such as information about its configuration.

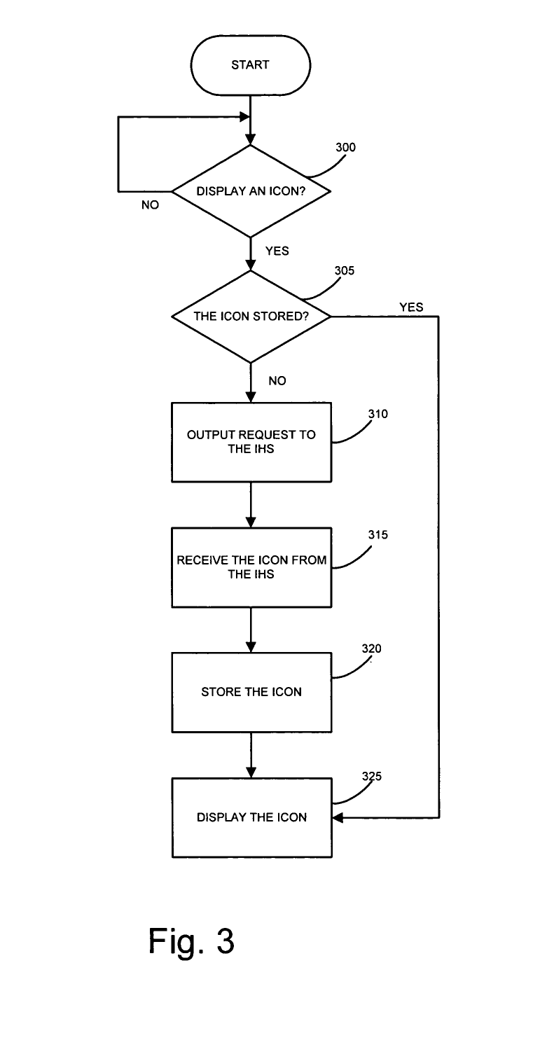

Moreover, the peripheral device 175 includes a USB connection interface 215 for coupling the peripheral device 175 to the USB controller 170 of the IHS 100. Via the USB connection interface 215, the peripheral device 175 receives and outputs information as discussed below in connection with FIG. 3.

As discussed above, the peripheral device 175 performs some of its various operations in association with a specific computer program (e.g., a computer program executed by the IHS 100). For performing the operations in such a manner, the peripheral device 175 displays on its display device 200, a menu of computer program selections available to the user.

Accordingly, FIG. 2B is an illustration of a visual image (e.g., “screen”), indicated generally at 240, displayed by the display device 200. The screen 240 includes a menu 250, which includes user selectable icons 255, 260, and 265. Each of the icons 255, 260, and 265 represents a computer program, in association with which, the peripheral device 175 is capable performing its operations. Via the menu 250 and the icons 255, 260, and 265, the peripheral device 175 receives a user selection for specifying the particular computer program desired by the user in performing one or more of such operations. Because the user is more likely to associate the computer program with its icon rather than its name or another textual representation, the user's experience in operating the peripheral device 175 is improved by displaying the icons 255, 260, and 265. To display the icons 255, 260, and 265, the IHS 100 and the peripheral device 175 perform the operations discussed below in connection with FIG. 3.

FIG. 2C is a block diagram of devices that are representative of the peripheral device 175. As shown, such representative devices include a camera 270, a printer 275, and a scanner 280. Also, each of the camera 270, the printer 275, and the scanner 280 respectively includes a display device 272, a display device 277, and a display device 282. Moreover, each of display devices 272, 277, and 282 is representative of the display device 200 of FIG. 2A.

FIG. 3 is a flow chart illustrating operations performed by the peripheral device 175. The operation begins at a step 300 where the peripheral device 175 self loops until it determines that it is specified to display an icon (e.g., one of the icons 255, 260, and 265) associated with a computer program. In one example, the peripheral device 175 makes a such determination in response to receiving a user selection to perform an operation that is capable of being performed in association with the computer program. For example, with a scanner, such an operation includes scanning a document in a file format readable by the computer program (e.g., Microsoft Word) that is selectable by a user. Thus, in response to receiving the user's selection to scan a document, the scanner displays an icon associated with a computer program, to aid the user in selecting a desired format for the document being scanned. As shown in FIG. 3, in response to determining that it is specified to display an icon associated with a computer program, the operation continues to a step 305.

At the step 305, the peripheral device 175 determines whether an icon (e.g., a file, readable by the peripheral device, containing information about the icon) suitable for display by the display device 200 is stored by the storage device 205. More particularly, the peripheral device 175 makes such determination by determining whether a suitable icon is stored as a part of the instructions 210 (e.g., the firmware). In response to the peripheral device 175 determining that the icon is stored by the storage device 200, the operation continues to a step 325. As shown, at the step 325, the peripheral device displays the icon on the display device 200.

Conversely, if it determines that a suitable icon is not stored by the storage device 175, the peripheral device 175 performs the operations discussed below to receive a suitable icon from the IHS 100. Accordingly, the operation continues to a step 310.

At the step 310, the peripheral device 175 outputs, to the IHS 100, a request for an icon suitable for display by the display device 200. More particularly, such request is output in response to executing the instructions 210. Also, such request is output to the IHS 100 via the USB connection interface 215 shown in FIG. 2, and received by the IHS 100 via the USB controller 170.

In response to the IHS 100 receiving the request, one or more instructions (e.g., instructions included by a device driver for the peripheral device 175) executed by the IHS 100, causes the IHS 100 to search the IHS 100's storage devices (e.g., media drives 155 and/or main memory 115) for an icon (e.g., a file, readable by the IHS 100, that includes information about the icon) associated with the computer program. The icon stored by the storage devices of the IHS 100 is in a format suitable for display by the IHS 100's display device (e.g., display device 130). In one example, the icon is a Microsoft Windows Operating System icon. Accordingly, the IHS 100 modifies the icon to form (e.g., create) another icon that is suitable for display by the display device 200 of the peripheral device 175. In one example, the IHS 100 modifies the icon suitable for display by the display device 130 by modifying information about the icon's image aspect ratio and/or size.

After forming the icon suitable for display by the display device 200, the IHS 100 outputs the icon to the peripheral device 175. Referring again to FIG. 3, at a step 315, the peripheral device 175 receives the icon output by the IHS 100. After the step 315, the operation continues to a step 320.

At the step 320, the peripheral device 175 stores the icon in the storage device 210. In the illustrative embodiment, the peripheral device 175 stores the icon as a part of the instructions 210 (e.g., the firmware). However, in other embodiments, the peripheral device 175 does not store the icon as a part of the instructions 210. By storing the icon in a storage device 210, the peripheral device 175 uses the stored icon in one or more subsequent situations where the icon is needed for display by the peripheral device 175. After the step 320, the operation continues to the step 325, where the peripheral device 175 displays the icon on the display device 200.

In the illustrative embodiment discussed above, the peripheral device 175 outputs a request to the IHS 100 for an icon as a need for displaying the icon arises. However, in an alternative embodiment, in response to completing its initialization operation (e.g., operation performed after being “powered on”), the peripheral device 175 outputs a request to the IHS 100 for one or more icons associated with computer programs, in association with which the peripheral device is capable of operating.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be constructed broadly and in manner consistent with the scope of the embodiments disclosed herein.

1. A method performed by an information handling system (“IHS”), the method comprising:
receiving, by the IHS, a request for an icon suitable for display by a peripheral device's display device; and
in response to the request, outputting, by the IHS, the icon.

2. The method of claim 1, wherein the display device is a liquid crystal display (“LCD”) panel.

3. The method of claim 1, wherein the icon is a first icon and comprising:
forming the first icon by modifying a second icon that is suitable for display by the IHS's display device.

4. The method of claim 3, wherein the modifying includes:
modifying an aspect ratio of the second icon.

5. The method of claim 3, wherein the modifying includes:
modifying a size of the second icon.

6. The method of claim 3, wherein the modifying includes:
modifying the second icon in response to one or more instructions executed by the IHS.

7. The method of claim 6, wherein a device driver includes the instructions.

8. The method of claim 1, wherein the request is made in response to the peripheral device executing one or more instructions stored in the peripheral device's storage device.

9. The method of claim 8, wherein firmware includes the instructions.

10. The method of claim 1, wherein the icon is stored by the peripheral device.

11. The method of claim 1, wherein the icon is associated with a computer program executed by the IHS.

12. The method of claim 1, wherein the peripheral device includes a printer.

13. The method of claim 1, wherein the peripheral device includes a scanner.

14. The method of claim 1, wherein the peripheral device includes a camera.

15. A method of operating a peripheral device including a display, the method comprising:
outputting a request, by the peripheral device, for an icon associated with a computer program;
receiving, by the peripheral device, the icon; and
displaying on the display device, by the peripheral device, the icon.

16. The method of claim 15, wherein the icon is received by the peripheral device from an IHS.

17. The method of claim 15, wherein the icon is selectable by a user, and the displaying includes:
displaying a menu including the icon.

18. The method of claim 15, wherein the peripheral device is a printer.

19. The method of claim 15, wherein the peripheral device is a scanner.

20. The method of claim 15, wherein the peripheral device is a camera.

21. An information handling system (“IHS”) comprising:
a processor; and
a memory, coupled to the processor, which stores instructions when executed, causes the IHS to receive a request for an icon suitable for display by a peripheral device's display device and in response to the request, output the icon.

22. The IHS of claim 21, wherein the display device is a liquid crystal display (“LCD”) panel.

23. The IHS of claim 21, wherein the icon is a first icon and the instructions, when executed, clause the IHS to form the first icon by modifying a second icon that is suitable for display by the IHS's display device.

24. The IHS of claim 23, wherein the modifying includes:
modifying an aspect ratio of the second icon.

25. The IHS of claim 23, wherein the modifying includes:
modifying a size of the second icon.

26. The IHS of claim 23, wherein the modifying includes:
modifying the second icon in response to one or more instructions executed by the IHS.

27. The IHS of claim 26, wherein a device driver includes the instructions.

28. The IHS of claim 21, wherein the instructions are a first set of instructions and the request is made in response to the peripheral device executing a second set of instructions stored in the peripheral device's storage device.

29. The IHS of claim 28, wherein firmware includes the second set of instructions.

30. The IHS of claim 21, wherein the icon is stored by the peripheral device.

31. The IHS of claim 21, wherein the icon is associated with a computer program executed by the IHS.

32. The IHS of claim 21, wherein the peripheral device includes a printer.

33. The IHS of claim 21, wherein the peripheral device includes a scanner.

34. The IHS of claim 21, wherein the peripheral device includes a camera.

35. A peripheral device comprising:
a display device; and
a storage device, coupled to the display device, which stores instructions that when executed cause the peripheral device to output a request for an icon associated with a computer program, receive the icon, and display the icon on the display device.

36. The device of claim 35, wherein the peripheral device receives the icon from an IHS.

37. The device of claim 35, wherein the icon is selectable by a user, and the peripheral device displays a menu including the icon.

38. The device of claim 35, wherein the peripheral device is a printer.

39. The device of claim 35, wherein the peripheral device is a scanner.

40. The device of claim 35, wherein the peripheral device is a camera.

41. A method of displaying a familiar icon on a peripheral liquid crystal display (LCD) panel comprising:
coupling the peripheral with a personal computer (PC);
the peripheral sending a request to software on the PC;
the software sending the request to peripheral firmware for compatible applications;
the software locating and converting a familiar icon into an appropriate format for LCD display;
the software sending the icon to the peripheral firmware; and
the firmware displaying titles of PC compatible applications used with the familiar icon associated with the applications on the LCD in an appropriate mode.
